(19) United States
(12) Patent Application Publication
(10) Pub. No.: US 2004/0188871 A1
(43) Pub. Date: Sep. 30, 2004

(54) Holographic image shrink film and method for manufacture thereof

(75) Inventors: Tsung-Ming Shiao, Hsinchu (TW); Cheng-Hsiu Chen, Hsinchu (TW)

Correspondence Address: TROXELL LAW OFFICE PLLC, 5205 LEESBURG PIKE, SUITE 1404, FALLS CHURCH, VA, 22041, US

(73) Assignee: Klaser Technology Inc.

(21) Appl. No.: 10/397,191

(22) Filed: Mar. 27, 2003

(51) Int. Cl. B29D 11/00; G03H 1/02

(52) U.S. Cl. 264/1.31; 430/1; 430/2; 359/3

(57) ABSTRACT

A holographic image shrinkable film and the manufacture thereof is to spread a UV resin film on a shrinkable film; stick the UV resin film tightly against a metal wheel engraved with a holographic pattern, holographic film or separating type hot stamping film; illuminate the UV resin film with an UV lamp so as to harden the UV resin film instantly; and remove the harden UV resin film from the metal wheel, the holographic film, or separating type hot stamping film; the holographic pattern on the metal wheel or the holographic film is copied onto the UV resin film, or a separating type hot stamping film substrate is combined on the UV resin film. The manufacturing method according to the present invention is rather not dangerous, and a specialist is not need. Therefore, a mass production can be practiced to save production cost can be saved.

### BACKGROUND OF THE INVENTION

1. Field of the Invention

The present invention relates to a holographic image shrinkable film and the manufacturing method thereof. The method used is to spread an ultraviolet (UV) resin film on a shrinkable film, and then a holographic image is formed on the UV resin film so as to allow the shrinkable film to have a holographic image thereon. The holographic shrinkable film can be used to wrap a book, CD case, aluminum can and etc. as their appearance. And, the holographic image can also be used as a forging-prevention symbol.

2. Description of Related Art

A shrinkable film product such as PET, PVC and OPP has been used as a wrapping material for many articles since long time ago, because it can decorate and protect an article. And, a holographic image has functions such as remarkable beautification and counterfeit proof. Therefore, a shrinkable film used in wrapping an article will be artistic and forging-prevention.

A holographic shrinkable wrap element and method for manufacture thereof is disclosed in U.S. Pat. No. 6,459,513. The method according to the patent is to combine a holographic polymer film with adhesive, and then to combine with shrinkable wrap film. Thereafter, remove the holographic polymer film after being illuminated by electron beam to harden the adhesive. Therefore, the holographic image is printed on the adhesive so that the shrinkable wrap film has the holographic image thereon.

According to the description, the adhesive use in the patent is an electron beam curable coating or cold laminating adhesive. The electron beam curable coating can be urethane, polyester acrylates or epoxy acrylates. And, the cold laminating adhesive is pressure sensitive and can be solvent or water-based chemistry such as urethanes, polyesters or rubber. It is easy to form a thin film and to print without heating if the above-mentioned electron beam curable coating or adhesive is used.

But, an electron beam former must be facilitated to produce electron beam to illuminate the adhesive to harden the adhesive. The facility is expensive and the operation of the facility is rather dangerous. Taking Taiwan as an example, the technician that handles an electron beam former facility must be certified. Such kind of technology is not so popular that it cannot be utilized in a mass production of the holographic shrinkable wrap element. Besides, the electron beam former facility is rather expensive, it will lead the holographic shrinkable wrap element to have a higher price.

### SUMMARY OF THE INVENTION

Owing to large usage capacity of holographic shrinkable film, and for providing a general safe technology to process the mass production of low cost holographic shrinkable films, the present invention is brought up.

The main object of the present invention is to provide a holographic image shrinkable film and the manufacture thereof, the manufacture is rather safe, and a mass production can be carried out without persons with special skill so as to save production cost.

Another object of the present invention is to provide a holographic image shrinkable film with a hot stamping structure and the manufacture thereof, enabling the image of a holographic image shrinkable film to be more colorful, bright and artistic.

### BRIEF DESCRIPTION OF THE DRAWINGS

The present invention can be more fully understood by reference to the following description and accompanying drawings, in which:

FIG. 1 is a cross sectional schematic view of connection of a shrinkable film spread with UV resin according to the present invention;

FIG. 2 is a schematic view showing a manufacture of a holographic image shrinkable film of the first embodiment according to the present invention;

FIG. 3 is a cross sectional schematic view of a holographic image shrinkable film according to the present invention;

FIG. 4 is a schematic view showing a manufacture of a holographic image shrinkable film of the second embodiment according to the present invention;

FIG. 5 is a schematic view showing a manufacture of a holographic image shrinkable film of the third embodiment according to the present invention; and

FIG. 6 is a cross sectional schematic view of a holographic image shrinkable film of another embodiment according to the present invention.

### DETAILED DESCRIPTION OF THE PREFERRED EMBODIMENTS

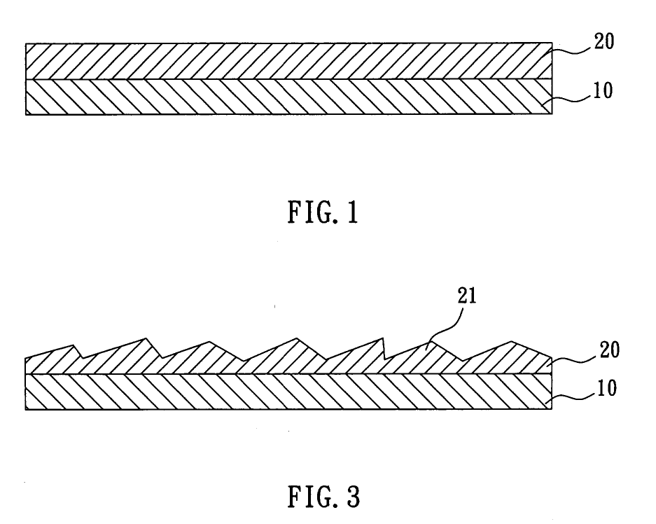

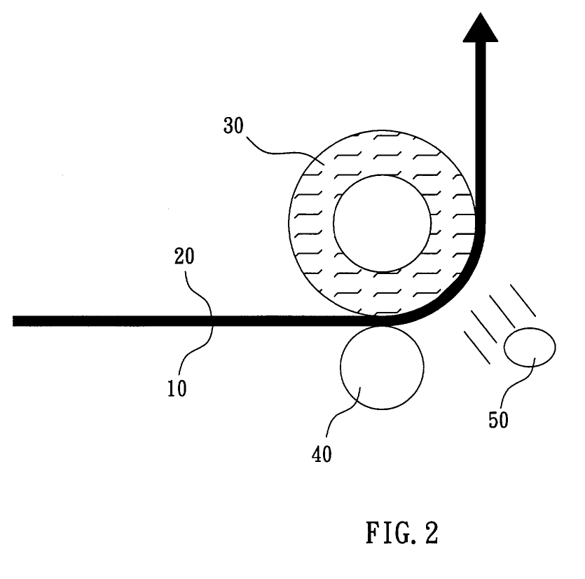

Please refer to FIGS. 1, 2 and 3. The method according to the present invention is to spread a UV resin film 20 with approximate thickness 1-10 um on a plastic shrinkable film 10 such as PET, PVC or OPP by using off-set printing or gravure printing as FIG. 1 shows. And then, stick the UV resin 20 on a metal wheel 30 engraved with a holographic pattern, and press a roller wheel 40 toward the metal wheel 30 from the side that the shrinkable film 10 is disposed as FIG. 2 shows. Thereby, the UV resin 20 is tightly stuck on the engraved lines of the holographic pattern on the metal wheel 30. And then, illuminate the UV resin film 20 that is stuck on the metal wheel 30 with UV lamp 50 to harden the UV resin film 20 instantly. The UV resin film 20 is combined tightly with the shrinkable film 10 after the illumination of the UV lamp 50, because good adhesion ability exists between UV resin film 20 and the shrinkable film 10. Remove the harden UV resin film 10 from the metal wheel 30, the holographic pattern on the metal wheel 30 will be copied onto the UV resin film 20 so as to leave the shrinkable film 10 with the holographic image 21 as FIG. 3 shows. The plastic shrinkable film used in this embodiment can be the shrinkable film (HISHIREX 602 (40 μm), 406-S (50 μm) or L (40 μm)) manufactured by Mitsubishi Plastic Inc. The UV resin can be the UV resin (UCB 245) manufactured by UCB Company in the United States.

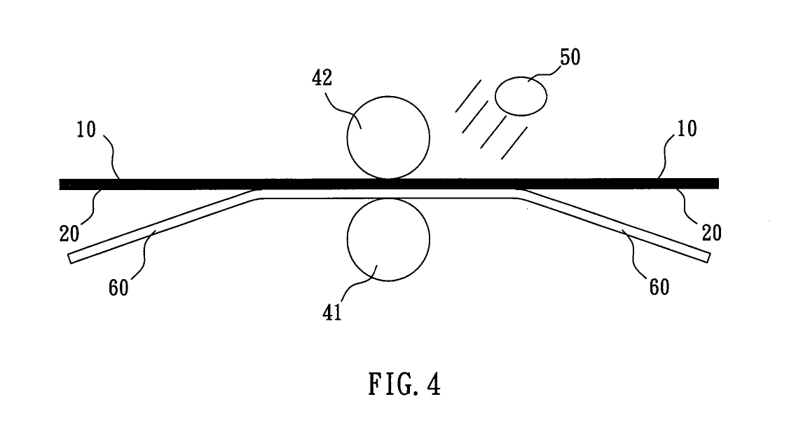

Please refer to FIG. 4. The manufacture of a holographic image shrinkable film of the second embodiment according to the present invention is to stick the shrinkable film 10 spread with the UV resin 20 shown in FIG. 1 with a holographic film 60 (such as OPP, PET or PVC plastic shrinkable film or smoothing agent coated composition film). And then, press two rollers wheel 41 and 42 inward respectively from the outsides of the holographic film 60 and the shrinkable film 10 to stick the UV resin film 20 tightly together with the engraved lines of the holographic pattern on the holographic film 60. Thereafter, the UV resin film 20 is harden instantly with the illumination of the UV lamp 50 and the holographic pattern on the holographic film 60 will be copied onto the UV resin film 20. Finally, remove the holographic film 60 from the UV resin film 20 to leave a holographic image on the shrinkable film 10. The holographic film 60 can be repeatedly used. The holographic film used in the embodiment can be the OPP holographic plastic film (K OPP 20) manufactured by the applicant of the present invention.

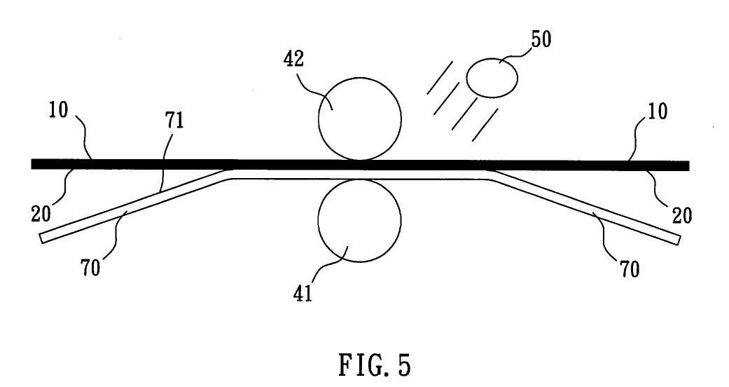

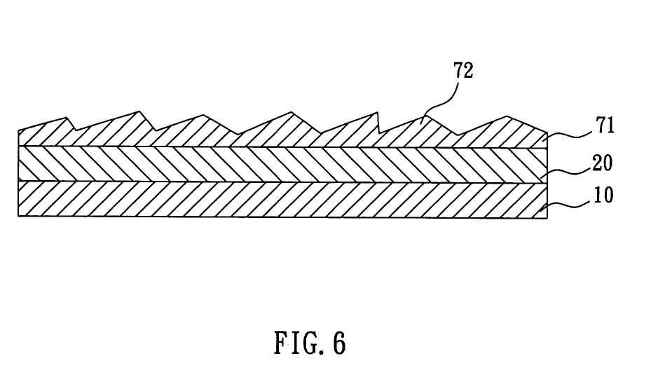

Finally, please refer to FIGS. 5 and 6. The manufacture of a holographic image shrinkable film of the third embodiment according to the present invention is almost as same as the process steps of the second embodiment mentioned above. The only difference is that a separating type hot stamping foil 70 engraved with a holographic pattern is used in the third embodiment to replace the holographic film 60 shown in FIG. 4. This can allow the UV resin film 20 to combine with a separating type hot stamping foil substrate 71 so as to leave a different color holographic image 72 on the holographic image shrinkable film 10 whenever a different material of separating type hot stamping foil substrate 71 is chosen; this can have more bright and artistic effect. The hot stamping foil used in this embodiment can be the hot stamping foil (K20μ) manufactured by the applicant of the present invention. And, the UV resin used for the hot stamping foil can be the UV resin (K-KV04) manufactured by the applicant of the present invention or the UV resin (BEACON 4520) manufactured by BEACON Company in the United States.

The UV resin and the UV lamp used in the present invention are all popularly used in the industry and are not dangerous. The illumination facilities of the UV lamp are much cheaper than the illumination facilities. And, a certificated specialist is unnecessary for operating the facilities; only a general operator is enough. A mass production can be practiced so that a large amount of manufacture cost can be saved. Therefore, the holographic image shrinkable film has a lower price.

It is noted that the holographic image shrinkable film and the manufacture thereof described above is the preferred embodiment of the present invention for the purpose of illustration only, and are not intended as a definition of the limits and scope of the invention disclosed. Any modifications and variations that maybe apparent to a person skilled in the art are intended to be included within the scope of the present invention.

What is claimed is:

1. A holographic image shrinkable film, comprising a shrinkable film combined with a UV resin, wherein said UV resin has a holographic image thereon.

2. The film according to claim 1, wherein said holographic image is formed by a separating type hot stamping film substrate with a holographic image combined with said UV resin.

3. A method for manufacturing a holographic image shrinkable film, comprising the following steps:
(1) spreading a UV resin film on a shrinkable film;
(2) sticking said UV resin film tightly against a metal wheel engraved with a holographic pattern;
(3) illuminating said UV resin film stuck tightly with said metal wheel with an UV lamp so as to harden said UV resin film instantly; and
(4) removing said harden UV resin film from said metal wheel, said holographic pattern on said metal wheel being copied onto said UV resin film.

4. The method according to claim 3, wherein said step (2) comprises pressing a roller wheel toward said metal wheel from another side of said shrinkable film so as to stick said UV resin film tightly with the engraved lines of said holographic pattern on said metal wheel.

5. A method for manufacturing a holographic image shrinkable film, comprising the following steps:
(1) spreading a UV resin film on a shrinkable film;
(2) sticking said UV resin film tightly against a holographic film;
(3) illuminating said UV resin film stuck tightly with said holographic film with an UV lamp so as to harden said UV resin film instantly; and
(4) removing said harden UV resin film from said holographic film, a holographic pattern on said holographic film being copied onto said UV resin film.

6. The method according to claim 5, wherein said step (2) comprises pressing two roller wheels inward from the outsides of said holographic film and said shrinkable film respectively so as to stick said UV resin film tightly with the engraved lines of said holographic pattern on said holographic film.

7. A method for manufacturing a holographic image shrinkable film, comprising the following steps:
(1) spreading a UV resin film on a shrinkable film;
(2) sticking said UV resin film tightly against a separating type hot stamping film engraved with a holographic pattern;
(3) illuminating said UV resin film stuck tightly with said separating type hot stamping film with an UV lamp so as to harden said UV resin film instantly; and
(4) removing said harden UV resin film from said separating type hot stamping film, a separating type hot stamping film substrate on said separating type hot stamping film being combined on said UV resin film.

8. The method according to claim 7, wherein said step (2) comprises pressing two roller wheels inward from the outsides of said separating type hot stamping film and said shrinkable film respectively so as to stick said UV resin film tightly with said separating type hot stamping film substrate with said holographic pattern on said separating type hot stamping film.
